(19) United States
(12) Patent Application Publication
(10) Pub. No.: US 2018/0341266 A1
(43) Pub. Date: Nov. 29, 2018

(54) TRAVELING APPARATUS, TRAVELING SYSTEM, AND OPERATION DEVICE

(71) Applicant: Sharp Kabushiki Kaisha, Osaka (JP)

(72) Inventor: Takeshi MORIMURA, Sakai City (JP)

(21) Appl. No.: 15/980,800

(22) Filed: May 16, 2018

(30) Foreign Application Priority Data
May 23, 2017 (JP) 2017-102022

(51) Int. Cl. G05D 1/02

(52) U.S. Cl. CPC G05D 1/0214; G05D 1/0223; G05D 1/0276

(57) ABSTRACT

A traveling apparatus includes a housing, a travel driving unit that drives the housing such that the housing travels along a road surface, a travel environment information acquisition unit that acquires travel environment information concerning an environment around the housing, a communication unit that receives a first travel command value responsive to a travel command from an external control device to the housing, a travel command value converting unit that converts the first travel command value into a second travel command value, and a travel control unit that controls the travel driving unit in response to the second travel command value. The travel command value converting unit varies a conversion rate from the first travel command value to the second travel command value in accordance with the travel environment information.

### BACKGROUND

### 1. Field

The present disclosure relates to traveling apparatuses, travel control methods, travel control programs, traveling systems, and operation devices. More specifically, the present disclosure relates to a traveling apparatus having a travel control functionality of a controller, and a travel control method, a travel control program, a travel control system, and an operation device, each controlled by the controller.

### 2. Description of the Related Art

Autonomous traveling vehicles that move autonomously are today used as traveling apparatuses. The autonomous traveling vehicles include a conveying robot that coveys a cargo, and a surveillance robot that monitors the inside and surroundings of a building, and a state of a specific premise. Autonomous traveling robots with a camera, a variety of sensors, arms, booms, and the like are used for search of victims in disaster-stricken areas of earthquakes, tsunamis, or landslide, or for activities in hazardous areas, such as collecting information on an inside state of a plant or an electric power plant that has been damaged by an accident. See Japanese Unexamined Patent Application Publication No. 2005-111595, for example.

Such autonomous traveling vehicles have a travel control functionality to travel, halt, accelerate, decelerate, and steer. In addition to the functionality, the autonomous vehicle also has a safety control functionality to perform collision avoidance control, and deceleration and halt control to ensure safety of traveling via avoiding an obstacle if the obstacle is detected during the autonomous traveling.

Some autonomous traveling vehicles of related art have a manual traveling mode in which manual travel control by a controller is performed, in addition to an autonomous traveling mode in which a vehicle autonomously travels. The autonomous traveling vehicle switches between the autonomous travel mode and the manual travel mode.

A control method using a controller is available as a related art technique. An operation lever as the controller controls the traveling of a vehicle by tilting an operation lever forward, backward, rightward or leftward. If the operation lever is tilted forward, the vehicle travels forward, and if the operation lever is tilted backward, the vehicle travels backward. As the operation lever is tilted forward or backward in a larger angle, the speed of the vehicle increases, and as the operation lever is tilted forward or backward in a smaller angle, the speed of the vehicle decreases.

If the operation lever is tilted rightward, the vehicle turn rightward, and if the operation lever is tilted leftward, the vehicle turns leftward. As the operation lever is tilted rightward or leftward in a larger angle, the speed of the vehicle increases, and as the operation lever is tilted rightward or leftward in a smaller angle, the speed of the vehicle decreases.

If the operation lever is tilted in a slant direction, the vehicle moves at a speed of combination of a rate of change in the speed of the vehicle when the operation lever is tilted in a fore-aft direction and a rate of change in the turning speed when the operation lever is tilted in a lateral direction. Note that if the operation lever is tilted laterally only without being tilted in the fore-aft direction, the vehicle turns around the center axis of the vehicle.

In one of related art techniques, an upper limit is imposed on a travel speed of a vehicle or the vehicle is forced to stop if an obstacle is detected during the traveling of the vehicle. A collision against the obstacle is thus avoided. If an operation lever is tilted in excess of a range above the upper limit when the upper limit is imposed on the travel speed of the vehicle, this operation is not reflected in the speed of the vehicle. Since the operation range of the operation lever is narrowed, the driver has operation difficulty.

### SUMMARY

It is desirable to provide a traveling apparatus, a travel control method, a travel control program, a travel control system, and an operation device for performing appropriate control in response to a surrounding environment without reducing the operability of a controller.

According to one aspect, there is provided a traveling apparatus. The traveling apparatus includes a housing, a travel driving unit that drives the housing such that the housing travels along a road surface, a travel environment information acquisition unit that acquires travel environment information concerning an environment around the housing, a communication unit that receives a first travel command value responsive to a travel command from an external control device to the housing, a travel command value converting unit that converts the first travel command value into a second travel command value, and a travel control unit that controls the travel driving unit in response to the second travel command value. The travel command value converting unit varies a conversion rate from the first travel command value to the second travel command value in accordance with the travel environment information.

According to another aspect, there is provided a travel control method. The travel control method includes driving a housing such that the housing travels along a road surface, acquiring travel environment information concerning an environment around the housing, receiving a first travel command value from an external control device, converting the first travel command value into a second travel command value, controlling traveling of the housing in response to the second travel command value. The converting includes varying a conversion rate from the first travel command value to the second travel command value in accordance with the travel environment information.

According to another aspect, there is provided a travel control program. The travel control program causes a processor of a traveling apparatus to perform a process. The process includes driving a housing such that the housing travels along a road surface, acquiring travel environment information concerning an environment around the housing, receiving a first travel command value from an external control device, converting the first travel command value into a second travel command value, controlling traveling of the housing in response to the second travel command value. The converting includes varying a conversion rate from the first travel command value to the second travel command value in accordance with the travel environment information.

According to another aspect, there is provided a traveling system. The traveling system includes a traveling apparatus, a control device, and a server. The control device includes an operation unit that receives a travel command to the traveling apparatus, and a control device transmitting unit that transmits a first travel command value responsive to the travel command. The server includes a server receiving unit that receives the first travel command value from the control device, and receives, from the traveling apparatus, travel environment information concerning an environment around the traveling apparatus, a travel command value converting unit that converts the first travel command value into a second travel command value, and a server transmitting unit that transmits the second travel command value to the traveling apparatus. The traveling apparatus includes a housing, a travel driving unit that drives the housing such that the housing travels along a road surface, a travel environment information acquisition unit that acquires the travel environment information concerning the environment around the housing, a traveling apparatus transmitting unit that transmits the travel environment information to the server, a traveling apparatus receiving unit that receives the second travel command value from the server, and a travel control unit that controls the travel driving unit in response to the second travel command value. The travel command value converting unit varies a conversion rate from the first travel command value to the second travel command value in accordance with the travel environment information.

According to another aspect, there is provided an operation device. The operation device includes an operation unit that performs a predetermined operation in response to an operation command from an external control device, an environment information acquisition unit that acquires environment information concerning an environment around the operation unit, a communication unit that receives a first operation command value responsive to the operation command from the external control device to the operation unit, an operation command value converting unit that converts the first operation command value into a second operation command value, and an operation control unit that controls an operation of the operation unit in response to the second operation command value. The operation command value converting unit varies a conversion rate from the first operation command value to the second operation command value in accordance with the environment information.

### BRIEF DESCRIPTION OF THE DRAWINGS

FIG. 1 is a left-side view of an autonomous traveling vehicle of a first embodiment of the disclosure;

FIG. 2 is a plan view of the autonomous traveling vehicle of FIG. 1;

FIG. 3A is a right-side view diagrammatically illustrating a motorized vehicle frame of the autonomous traveling vehicle of the first embodiment;

FIG. 3B is a sectional view taken along line IIIB-IIIB in FIG. 3A;

FIG. 4 is a functional block diagram illustrating travel control of the autonomous traveling vehicle of the first embodiment;

FIG. 5 is a configuration block diagram of the controller of the first embodiment;

FIG. 6 is an external plan view of the controller of FIG. 5;

FIG. 7A and FIG. 7B are tables indicating a correspondence relationship of travel command values when being input (input travel command values) and after being converted (converted travel command values) in travel command value conversion tables, wherein FIG. 7A indicates an example of the correspondence relationship of the input and converted travel command values in normal traveling of the vehicle, and FIG. 7B indicates an example of the correspondence relationship a of the input and converted travel command values in low-speed traveling of the vehicle;

FIG. 8 illustrates a graph indicating the correspondence relationship of the input and converted travel command values in the travel command value conversion tables of FIG. 7A and FIG. 7B;

FIG. 9 is a flowchart illustrating a travel control process of the autonomous traveling vehicle during manual traveling;

FIG. 10 diagrammatically illustrates how a travel command value conversion table is selected;

FIG. 11A and FIG. 11B are tables indicating a correspondence relationship of the input and converted travel command values in travel command value conversion tables for a narrow road, wherein FIG. 11A indicates an example of the conversion relationship of the travel command values of a speed component, and FIG. 11B indicates an example of the conversion relationship of the travel command values of a turning component;

FIG. 12A and FIG. 12B are graphs indicating the conversion relationships of the travel command values in terms of the speed component and the turning component, wherein FIG. 12A indicates an example of the conversion relationship of the travel command values in the speed component, and FIG. 12B indicates an example of the conversion relationship of the travel command values in the turning component;

FIG. 13 is a graph indicating an example of the conversion relationship of the travel command values in the speed component of an autonomous traveling vehicle of related art;

FIG. 14 is a graph indicating an example of the conversion relationship of the travel command values in the speed component of the autonomous traveling vehicle of the first embodiment;

FIG. 15 is a flowchart illustrating a travel control process of the autonomous traveling vehicle during automotive traveling;

FIG. 16A and FIG. 16B are tables indicating the conversion relationships of the input and converted travel command values in the travel command value conversion tables for a narrow width road, wherein FIG. 16A indicates an example of the conversion relationship of the travel command values in the speed component, and FIG. 16B indicates an example of the conversion relationship of the travel command values in the turning component;

FIG. 17A and FIG. 17B are graphs indicating the conversion relationships of the travel command values in terms of the speed component and the turning component, wherein FIG. 17A indicates an example of the conversion relationship of the travel command values in the speed component, and FIG. 17B indicates an example of the conversion relationship of the travel command values in the turning component;

FIG. 18 is a flowchart illustrating an example of a selection process of the travel command value conversion tables of an autonomous traveling vehicle of a second embodiment of the disclosure;

FIG. 19 is a table illustrating the conversion relationship the input and converted travel command values in the travel command value conversion tables in the turning component for a wide area;

FIG. 20 is a graph indicating the conversion relationship of the travel command values in the turning component of FIG. 19;

FIG. 21 is a table indicating the correspondence relationship of the input and converted travel command values in the travel command value conversion table in the speed component for a high-speed region;

FIG. 22 is a graph indicating the conversion relationship of the travel command values in the speed component of FIG. 21; and

FIG. 23 is a functional block diagram diagrammatically illustrating a traveling system of a seventh embodiment.

### DESCRIPTION OF THE EMBODIMENTS

In one aspect of the disclosure, a traveling apparatus includes a housing, a travel driving unit that drives the housing such that the housing travels along a road surface, a travel environment information acquisition unit that acquires travel environment information concerning an environment around the housing, a communication unit that receives a first travel command value responsive to a travel command from an external control device to the housing, a travel command value converting unit that converts the first travel command value into a second travel command value, and a travel control unit that controls the travel driving unit in response to the second travel command value. The travel command value converting unit varies a conversion rate from the first travel command value to the second travel command value in accordance with the travel environment information.

In another aspect of the disclosure, a travel control method includes driving a housing such that the housing travels along a road surface, acquiring travel environment information concerning an environment around the housing, receiving a first travel command value from an external control device, converting the first travel command value into a second travel command value, controlling traveling of the housing in response to the second travel command value. The converting includes varying a conversion rate from the first travel command value to the second travel command value in accordance with the travel environment information.

In another aspect of the disclosure, a travel control program causes a processor of a traveling apparatus to perform a process. The process includes driving a housing such that the housing travels along a road surface, acquiring travel environment information concerning an environment around the housing, receiving a first travel command value from an external control device, converting the first travel command value into a second travel command value, and controlling traveling of the housing in response to the second travel command value. The converting includes varying a conversion rate from the first travel command value to the second travel command value in accordance with the travel environment information.

In another aspect of the disclosure, a traveling system includes a traveling apparatus, a control device, and a server. The control device includes an operation unit that receives a travel command to the traveling apparatus, and a control device transmitting unit that transmits a first travel command value responsive to the travel command. The server includes a server receiving unit that receives the first travel command value from the control device, and receives, from the traveling apparatus, travel environment information concerning an environment around the traveling apparatus, a travel command value converting unit that converts the first travel command value into a second travel command value, and a server transmitting unit that transmits the second travel command value to the traveling apparatus. The traveling apparatus includes a housing, a travel driving unit that drives the housing such that the housing travels along a road surface, a travel environment information acquisition unit that acquires the travel environment information concerning the environment around the housing, a traveling apparatus transmitting unit that transmits the travel environment information to the server, a traveling apparatus receiving unit that receives the second travel command value from the server, and a travel control unit that controls the travel driving unit in response to the second travel command value. The travel command value converting unit varies a conversion rate from the first travel command value to the second travel command value in accordance with the travel environment information.

In another aspect of the disclosure, the operation device includes an operation unit that performs a predetermined operation in response to an operation command from an external control device, an environment information acquisition unit that acquires environment information concerning an environment around the operation unit, a communication unit that receives a first operation command value responsive to the operation command from the external control device to the operation unit, an operation command value converting unit that converts the first operation command value into a second operation command value, and an operation control unit that controls an operation of the operation unit in response to the second operation command value. The operation command value converting unit varies a conversion rate from the first operation command value to the second operation command value in accordance with the environment information.

The “external control device” is an external controller that controls the traveling of the housing. The “travel environment information” includes information concerning the state of a road surface on which the housing travels, information concerning an obstacle present around the housing, and information indicating a travel environment of the housing, such as weather information. The “travel command value” is a numerical value into which a travel command to the housing is represented. More specifically, the travel command value is associated with the number of revolutions of an electric motor that drives the travel driving unit. The “travel command value” may be based on an amount of operation of a user or may be based on an amount of control of a computer. The “operation unit” is an element, such as an arm or a shovel, and performs a predetermined operation in response to an operation command from the external control device. The “operation” includes a traveling operation that causes the traveling apparatus to travel in response to a travel command. The “environment information of the environment” is related to an operation environment, including information concerning the environment surrounding the operation device, such as temperature or humidity, and weather information, such as windy, rainy, snowing, or foggy. The “operation device” performs an predetermined operation in response to an operation command from the external control device. The operation device may be a device having an operation unit, such as an arm or a shovel, or may be a humanoid robot, or a traveling apparatus.

The “travel driving unit” of an embodiment of the disclosure is implemented when electric motors 41R and 41L, motor shafts 42R and 42L, and gear boxes 43R and 43L work in cooperation with each other. The “travel control unit” is implemented by a motor controller 108, and the “travel environment information acquisition unit” is implemented by a distance detection device 12. The “control device” is implemented by the controller 2. The “server receiving unit” and the “server transmitting unit” are implemented by the communication unit 104. The “traveling apparatus transmitting unit” and the “traveling apparatus receiving unit” are implemented by the communication unit 109.

The traveling apparatus in an aspect may include elements as described below, and these elements may be combined.

The travel environment information may include information concerning a state of the road surface.

The traveling apparatus may thus be implemented that appropriately performs speed control of a vehicle in response to the state of the road surface without reducing the operability of the controller.

The travel environment information may include information concerning an obstacle present around the housing.

The traveling apparatus may be implemented that appropriately performs speed control of the vehicle in response to the state of the ambient obstacle without reducing the operability of the controller.

The traveling apparatus may include a memory that stores conversion data that indicates a conversion relationship from the first travel command value to the second travel command value. If the memory stores multiple pieces of the conversion data responsive to the travel environment information, the travel command value converting unit converts the first travel command value into the second travel command value in accordance with a single piece of the conversion data selected from the multiple pieces of the conversion data in view of the travel environment information.

Based on the travel environment information, the travel command value converting unit converts the first travel command value into the second travel command value in accordance with the single piece of the conversion data selected from the multiple pieces of the conversion data. The traveling apparatus may thus be implemented that appropriately performs speed control of the vehicle in response to the travel environment information without reducing the operability of the controller.

The “memory” is implemented by a travel command conversion table memory 107, and the “conversion data” is implemented by travel command value conversion tables T1, T2, and T3. The “conversion data” may be data determined by a specific formula (such as a straight line, a quadratic curve, or the like).

The traveling apparatus may further include an autonomous travel control unit that generates an autonomous travel command value for autonomous traveling of the housing.

If the first travel command value is received during the autonomous traveling of the housing, the travel control unit controls the travel driving unit in response to the autonomous travel command value and the second travel command value.

The traveling apparatus may thus be implemented that appropriately performs speed control of the vehicle in response to the travel environment information without reducing the operability of the controller when the controller performs the travel control during autonomous traveling.

If the communication unit receives the first travel command value during the autonomous traveling of the housing, the travel command value converting unit may convert the first travel command value into the second travel command value such that that the second travel command value is smaller than the autonomous travel command value, and, if a sum of the autonomous travel command value and the second travel command value exceeds a predetermined range, truncates an amount of the value of the sum in excess of the predetermined range.

Autonomous traveling is corrected by the controller, and the traveling apparatus may thus be implemented that appropriately performs speed control of the vehicle in response to the travel environment information without reducing the operability of the controller.

The travel environment information may include information concerning a width of the road surface.

In this way, the traveling apparatus may be implemented that appropriately performs speed control of the vehicle in response to the width of the road surface without reducing the operability of the controller.

The travel command value converting unit may convert the first travel command value into the second travel command value such that the second travel command value decreases as the width of the road surface becomes narrower.

The travel environment information may include information concerning a road gradient of the road surface.

In this way, the traveling apparatus may thus be implemented that appropriately performs speed control of the vehicle in response to the road gradient of the road surface without reducing the operability of the controller.

The travel environment information may include information concerning a slipping state of the road surface.

In this way, the traveling apparatus may thus be implemented that appropriately performs speed control of the vehicle in response to the slipping state of the road surface without reducing the operability of the controller.

In response to the travel environment information, the travel command value converting unit may vary the conversion rates in a forward direction, a backward direction, a leftward direction and a rightward direction of the housing such that the conversion rate in one direction becomes different from the conversion rate in another direction.

For example, the conversion rate may be set to be different between the fore-aft direction and the lateral direction, between the forward direction and the backward direction, or between the leftward direction and the rightward direction.

In this way, the traveling apparatus may thus be implemented that appropriately performs speed control of the vehicle in each of the fore-aft direction and the lateral direction of the vehicle in response to the travel environment without reducing the operability of the controller.

The travel environment information may include information concerning an object present around the housing, and the travel command value converting unit may vary the conversion rate in the forward direction of the housing in response to a detected distance to the object.

In this way, the traveling apparatus may be implemented that appropriately performs speed control of the vehicle in response to the detected distance to the object without reducing the operability of the controller.

The travel environment information may include information concerning an object present around the housing, and the travel command value converting unit may decrease the conversion rate in the forward direction of the housing as a detected distance to the object becomes shorter.

In this way, the speed of the vehicle becomes lower as the detected distance to the object decreases. The traveling apparatus may be implemented that appropriately performs speed control of the vehicle without reducing the operability of the controller.

The speed of the vehicle may gradually decrease as the detected distance to the object decreases.

If the first command value is equal to or below a reference value, the travel command value converting unit may convert the first travel command value into the second command value such that the second command value becomes zero, and varies the reference value in response to the travel environment information.

A change in the travel command value is not reflected when a travel command value from the controller is lower than the reference value. The traveling apparatus may be implemented that appropriately performs speed control of the vehicle without reducing the operability of the controller.

The communication unit may vary in response to the travel environment information a time interval according to which the first travel command value is received from the external control device.

In this way, the traveling apparatus may thus be implemented that appropriately sets a sensitivity to signal reception in response to the travel environment information.

The traveling apparatus has an increased sensitivity to signal reception by shortening the time interval of signal reception from the control device, for example, in a narrow area (such as an area of 6 m×6 m through 7 m×7 m surrounding the housing, more preferably an area of about 5 m×5 m or smaller).

The travel command value converting unit may vary a rate of acceleration or a rate of deceleration of the traveling of the housing in response to the travel environment information until the housing reaches a travel speed corresponding to the second travel command value.

In this way, the traveling apparatus may thus be implemented that has appropriate response performance by accelerating or decelerating the speed of the vehicle in response to the travel environment information.

The traveling apparatus has increased response performance at lower speed traveling by increasing the speed, for example, in a narrow area (such as an area of 6 m×6 m through 7 m×7 m surrounding the housing, more preferably an area of about 5 m×5 m or smaller).

Referring to the drawings, an autonomous traveling vehicle 1 is described as an example of the traveling apparatus as embodiments of the disclosure in detail. The description of the embodiments is not intended to limit the scope of the disclosure.

### First Embodiment

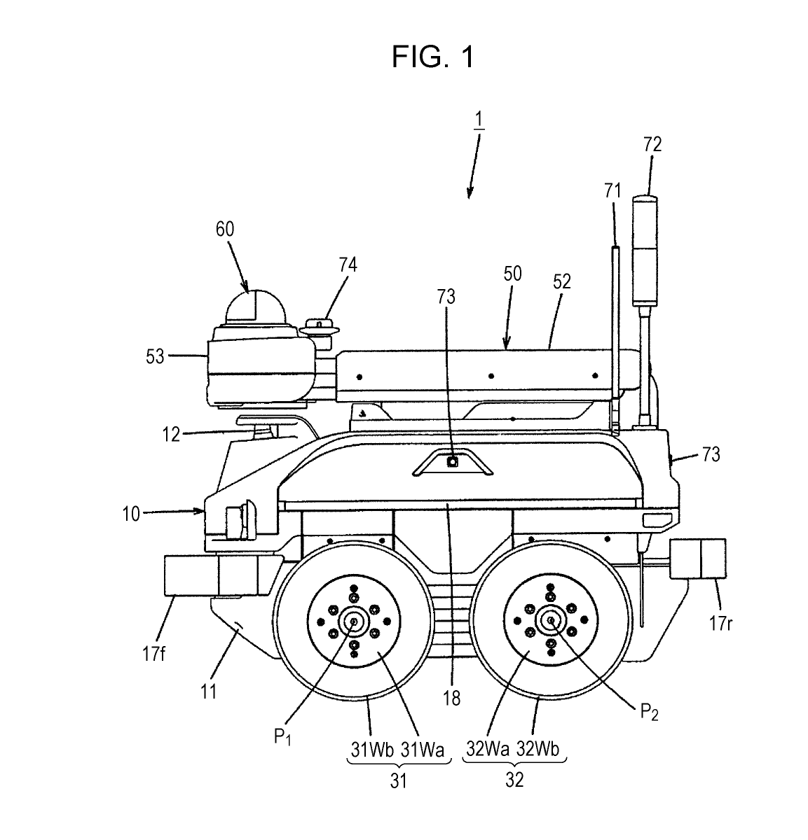

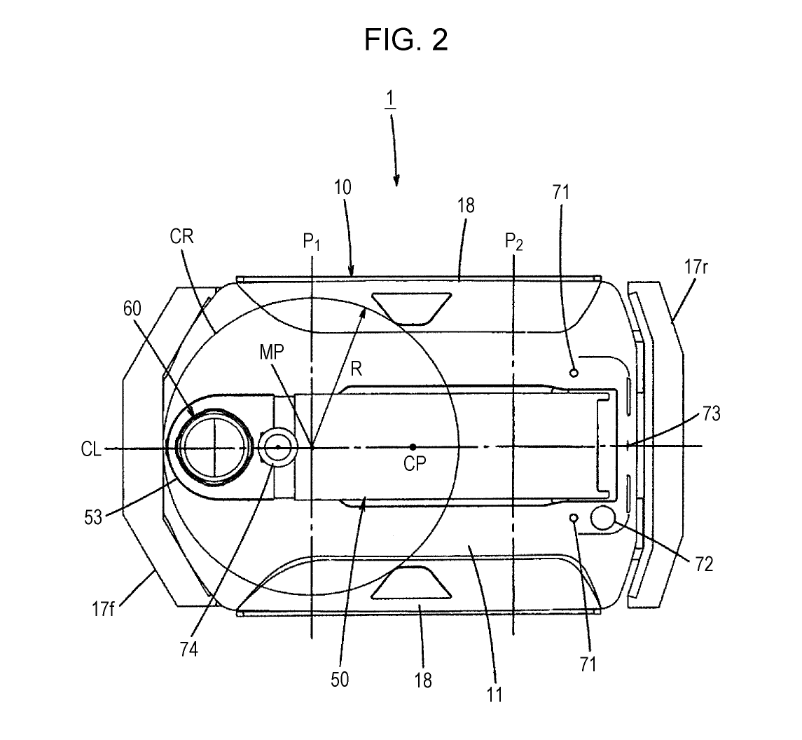

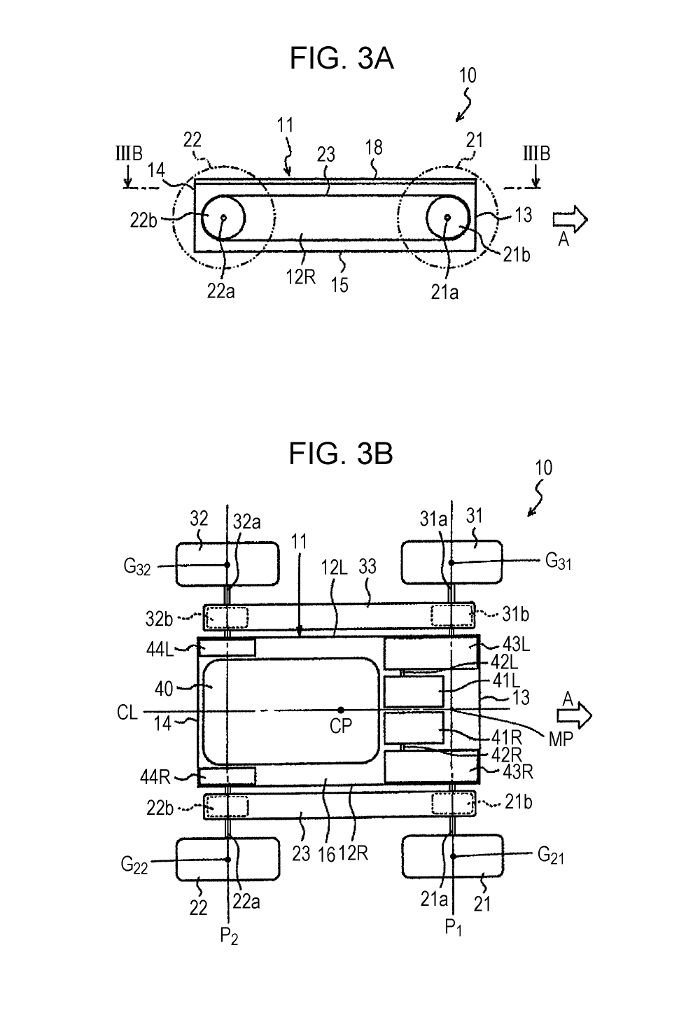

FIG. 1 is a left-side view of an autonomous traveling vehicle 1 of a first embodiment of the disclosure. FIG. 2 is a plan view of the autonomous traveling vehicle 1 of FIG. 1. FIG. 3A is a right-side view diagrammatically illustrating a motorized vehicle frame 10 of the autonomous traveling vehicle of the first embodiment. FIG. 3B is a sectional view taken along line IIIB-IIIB in FIG. 3A.

The autonomous traveling vehicle 1 of the first embodiment includes the motorized vehicle frame 10, a raise and lower mechanism 50 arranged on the motorized vehicle frame 10, and a surveillance camera 60 that serves as an imaging unit and is arranged in the front portion of the raise and lower mechanism 50.

More in detail, a distance detection device 12 is mounted at the front end of the motorized vehicle frame 10. A Wi-Fi antenna 71 and an alarm lamp 72 are mounted at the back end portion of the motorized vehicle frame 10. Charge-coupled (CCD) cameras 73 are respectively mounted on right-side, left-side, and back-side surfaces of the motorized vehicle frame 10. A global positioning system (GPS) antenna 74 is mounted behind the surveillance camera 60 on the front portion of the raise and lower mechanism 50.

The distance detection device 12 has a functionality of checking the state of a forward area and a road surface of the road ahead of the vehicle. The distance detection device 12 includes a light emitting unit that emits light, a light receiving unit that receives light, and a scan control unit that scans in the emission direction of light such that a light beam is directed to predetermined multiple measurement points in the forward space. The distance detection device 12 may be light detection and ranging or laser imaging detection and ranging (LIDAR). LIDAR measures a distance to multiple measurement points within a distance measurement region by emitting a laser light beam in a two-dimensional or a three-dimensional space in the distance measurement region.

The control unit 100 performs a travel functionality and a surveillance functionality of the autonomous traveling vehicle 1, and may include a controller (a travel controller and a safety controller), a human detecting unit, a command recognition unit, a communication unit, a command executing unit, and a memory.

The autonomous traveling vehicle 1 pre-stores travel path information and map information indicating an area to which the autonomous traveling vehicle 1 is heading. Using information acquired from the surveillance camera 60, the distance detection device 12 and the GPS system, the autonomous traveling vehicle 1 travels along a specific path while avoiding an object.

The autonomous traveling vehicle 1 recognizes the posture of an operator using the surveillance camera 60 and the distance detection device 12 in particular, and autonomously travels while verifying the state in the forward direction ahead of the motorized vehicle frame 10 in response to a command associated in advance with the posture. For example, if the presence of an obstacle or a step in the forward direction is detected, the motorized vehicle frame 10 may halt, turn, go backward, or go forward to change the course in order to avoid colliding the obstacle. The motorized vehicle frame 10 thus performs the functionality in response to the command.

The configuration related to the traveling of the autonomous traveling vehicle 1 is described with reference to FIG. 3A and FIG. 3B. A right front wheel 21 and a right rear wheel 22 are represented by a chain line with two dots as in FIG. 3A, and sprockets 21b, 22b, 31b, and 32b are represented by broken lines in FIG. 3B.

### Motorized Vehicle Frame

The motorized vehicle frame 10 includes a vehicle body 11, four wheels arranged at front right and left and rear right and left of the vehicle body 11, two electric motors 41R and 41L that independently rotationally drive a pair of right and left wheels on at least one of the front side and the rear side of the vehicle body 11, a battery 40 that feeds power to the electric motors 41R and 41L, a distance detection device 12, and a control unit 100.

In accordance with the first embodiment as illustrated in FIG. 3A and FIG. 3B, the motorized vehicle frame 10 moves in a direction labeled an arrow A, and the right and left wheels on the side of the arrow A are front wheels 21 and 31, and the remaining right and left wheels are rear wheels 22 and 32. The right and left front wheels 21 and 31 are independently rotationally drive-controlled by the two electric motors 41R and 41L, respectively. FIG. 3A and FIG. 3B simply illustrate the elements forming the motorized vehicle frame 10 and locations of the elements. The sizes of the elements of the motorized vehicle frame 10 and spacings between the elements do not necessarily match those of the motorized vehicle frame 10 illustrated in FIG. 1 and FIG. 2.

In the vehicle body 11, bumpers 17f and 17r are respectively mounted on a front-side face 13 and a rear-side face 14, and band-shaped covers 18 are mounted on the right-side face 12R and the left-side face 12L, which extend in the fore-aft direction of the vehicle body 11. Wheel shafts 21a and 31a and wheel shafts 22a and 32a that rotatably support the front wheels 21 and 31, and the rear wheels 22 and 32, respectively, are arranged on the lower portions of the covers 18. The wheel shafts 21a and 31a are aligned in the same first axis P1, while the wheel shafts 22a and 32a are aligned in the same second axis. The wheel shafts 21a, 31a, 22a, and 32a are independently rotatable if they are not linked via power transmission members.

The pair of the wheels 21 and 22 on the right hand side is operatively connected via a belt 23 and the pair of the wheels 31 and 32 on the left hand side is operatively connected by a belt 33, each belt serving as a power transmission member. More specifically, the sprocket 21b is fixed onto the wheel shaft 21a of the right front wheel 21, and the sprocket 22b is fixed onto the wheel shaft 22a of the rear wheel 22. The belt 23 is entrained around the sprocket 21b of the front wheel 21 and the sprocket 22b of the rear wheel 22 with inner teeth of the belt 23 in mesh with the sprockets 21b and 22b. Similarly, the sprocket 31b is fixed onto the wheel shaft 31a of the right front wheel 31, and the sprocket 32b is fixed onto the wheel shaft 32a of the rear wheel 32. The belt 33 is entrained around the sprocket 31b of the front wheel 31 and the sprocket 32b of the rear wheel 32 with inner teeth of the belt 33 in mesh with the sprockets 31b and 32b.

Since the right front and rear wheels (21 and 22) are operatively connected with each other via the belt 23 and the left front and rear wheels (31 and 32) are operatively connected with each other via the belt 33, one of the paired wheels is simply driven. In accordance with the first embodiment, the front wheels 21 and 31 function as driving wheels. If the wheels 21 and 31 are driving wheels, the wheels 22 and 32 are wheels that are driven via the belts 23 and 33 serving as the power transmission members without slipping. The power transmission members that operatively connect the front wheels to the rear wheels include the sprockets 21b and 31b, and the belts 23 and 33 that have inner teeth that are designed to be in mesh with the sprockets 21b and 31b. Alternatively, the power transmission members may include the sprockets 21b and 31b and chains that are designed to be in mesh with the sprockets 21b and 31b. If slipping is permissible, the power transmission members may include high friction pulleys and the belts 23 and 33. Note that the power transmission members are to be designed to cause the driving wheels and the driven wheels to have the same number of revolutions. Referring to FIG. 3A and FIG. 3B, the front wheels (21 and 31) are the driving wheels, and the rear wheels (22 and 32) are the driven wheels.

Two electric motors, namely, the right side electric motor 41R and the left side electric motor 41L are used. On a bottom surface 15 of the vehicle body 11 on the front wheel side, the electric motor 41R is arranged to drive the right front and rear wheels 21 and 22, and the electric motor 41L is arranged to drive the left front and rear wheels 31 and 32. A gear box 43R is arranged as a power transmission mechanism between the motor shaft 42R of the right electric motor 41R and a wheel shaft 21a of the right front wheel 21. Similarly, a gear box 43L is arranged as a power transmission mechanism between the motor shaft 42L of the left electric motor 41L and a wheel shaft 31a of the left front wheel 31. The two electric motors 41R and 41L are arranged in parallel symmetrically with respect to a center line CL along the advance direction (labeled an arrow A) of the vehicle body 11. The gear boxes 43R and 43L are respectively arranged outside the electric motors 41R and 41L.

Each of the gear boxes 43R and 43L includes multiple gears and shafts, and convey power from the electric motors 41R and 41L to the wheel shafts 21a and 31a as output shafts by changing torque, the number of revolutions, and the direction of rotation. Each of the gear boxes 43R and 43L may include a clutch that switches between conveying power and not conveying power. The pair of rear wheels 22 and 32 are rotatably supported about bearings 44R and 44L, and the bearings 44R and 44L are arranged close to a right-side face 12R and a left-side face 12L of the bottom surface 15 of the vehicle body 11.

In this configuration, the front and rear wheels 21 and 22 on the right-hand side and the front and rear wheels 31 and 32 on the left-hand side with respect to the advance direction are independently driven. More specifically, power of the right electric motor 41R is conveyed to the gear box 43R via the motor shaft 42R and the gear box 43R changes power in terms of the number of revolutions, torque, or the rotation direction before transmitting power to the wheel shaft 21a. With the wheel shaft 21a rotating, the front wheel 21 rotates. The rotary motion of the wheel shaft 21a is conveyed to the rear wheel shaft 22a via the sprocket 21b, the belt 23, and the sprocket 22b, causing the rear wheel 22 to rotate. The transmission of power from the left electric motor 41L to the front wheel 31 to the rear wheel 32 is performed in a way similar to the transmission of power on the right-hand side of the vehicle body 11.

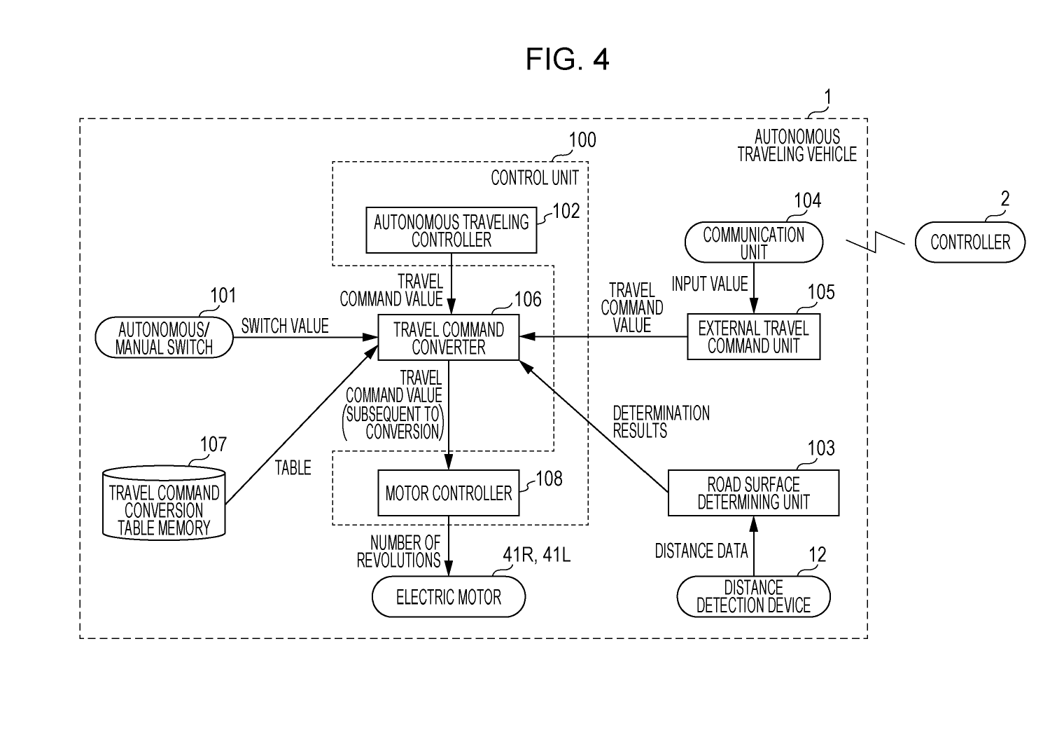

The configuration of the travel control of the autonomous traveling vehicle 1 of the first embodiment is described below with reference to FIG. 4. FIG. 4 is a functional block diagram illustrating the travel control of the autonomous traveling vehicle 1 of the first embodiment.

Referring to FIG. 4, the autonomous traveling vehicle 1 of the first embodiment includes an autonomous/manual switch 101, an autonomous traveling controller 102, a distance detection device 12, a road surface determining unit 103, a communication unit 104, an external travel command unit 105, a travel command converter 106, a travel command conversion table memory 107, a motor controller 108, electric motors 41R and 41L.

Elements of the autonomous traveling vehicle 1 of the first embodiment are described below.

The autonomous/manual switch 101 switches between traveling in an autonomous mode and traveling in a manual mode. The autonomous mode and the manual mode are described in detail below.

The autonomous traveling controller 102 controls the autonomous traveling vehicle 1 in starting or halting the travel action thereof, and controls autonomous traveling of the autonomous traveling vehicle 1. The autonomous traveling controller 102 also has functionalities of giving a travel command, controlling management, controlling traveling, halting, and steering, and controlling travel speed, acceleration and deceleration.

The autonomous traveling vehicle 1 includes a position fixing sensor fixing a position via GPS, global navigation satellite system (GLASS), or Bluetooth (registered trademark) to obtain position information. The autonomous traveling controller 102 transmits to the travel command converter 106 a travel command value that controls the traveling of the autonomous traveling vehicle 1. The autonomous traveling controller 102 thus causes the autonomous traveling vehicle 1 to travel along a travel route specified in advance, based on travel route map data that has been produced in accordance with the position information.

The distance detection device 12 emits a laser light beam in a two-dimensional space or three-dimensional space in a predetermined distance measurement region, measures a distance to each of multiple points within the distance measurement region, and inputs the measured distance data to the road surface determining unit 103 to be described below.

Based on the distance data measured by the distance detection device 12, the road surface determining unit 103 determines the road surface state, such as the width, length, and gradient of the road surface on which the autonomous traveling vehicle 1 is going to travel, and inputs the determination results to the travel command converter 106.

The communication unit 104 communicates with the controller 2. The communication unit 104 receives input values, such as a direction of tilt and a tilt angle of an operation lever 211 of the controller 2, and transmits the input values to the external travel command unit 105.

In response to the values input from the communication unit 104, the external travel command unit 105 inputs to the travel command converter 106 to be discussed below the travel command value that controls the traveling of the autonomous traveling vehicle 1.

Based on the travel command value conversion table stored on the travel command conversion table memory 107 to be discussed below, the travel command converter 106 converts the travel command value received from the autonomous traveling controller 102 or the external travel command unit 105, and then inputs the converted travel command value to the motor controller 108 described below.

During the autonomous traveling, the travel command converter 106 receives a command from the autonomous traveling controller 102 and a command from the controller 2. The command received from the controller 2 is handled as a correction value to the command from the autonomous traveling controller 102. During the manual traveling, the travel command converter 106 does not receive the command from the autonomous traveling controller 102 but receives only the command from the controller 2. The travel control during the autonomous traveling and the manual traveling is described in detail below.

Based on the detection results from the distance detection device 12, the travel command converter 106 performs control to avoid an obstacle when the obstacle, such as a human or a thing, is detected during the traveling of the autonomous traveling vehicle 1.

The travel command conversion table memory 107 stores a travel command value conversion table. The travel command value conversion table indicates a conversion relationship between a value associated with the input value from the operation lever 211 (the travel command value during inputting) and a value associated with the number of revolutions of the electric motors 41R and 41L (the travel command value subsequent to conversion).

The travel command value during inputting (input travel command value) is a value that is assigned to an input value of the operation lever 211. For example, a value within a range of from 0 to 255 is assigned to a tilt angle of the operation lever 211. As the tilt angle of the operation lever 211 increases, the travel command value increases.

A value within a range of from 0 to 1000 is assigned to the travel command value subsequent to conversion (converted travel command value), depending on the number of revolutions of the electric motors 41R and 41L. As the converted travel command value increases, the number of revolutions of the electric motors 41R and 41L increases.

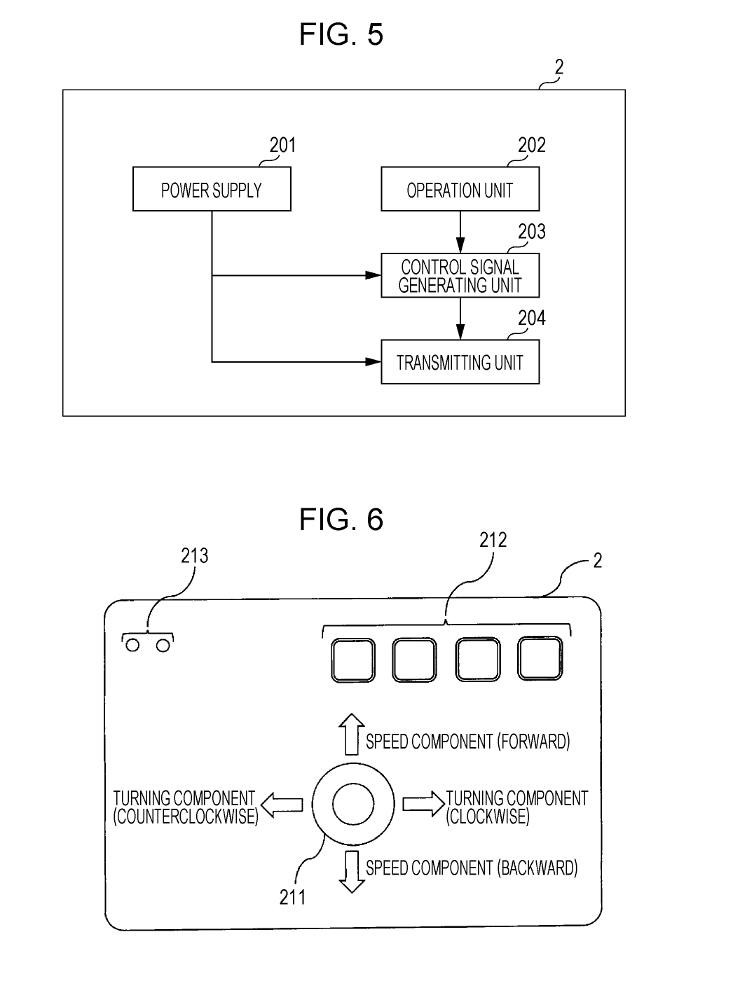

The general configuration of the controller 2 of the first embodiment of the disclosure is described with reference to FIG. 5 and FIG. 6. FIG. 5 is a configuration diagram of the controller 2 of the first embodiment. FIG. 6 is an external plan view of the controller 2 of FIG. 5.

Referring to FIG. 5, the controller 2 of the first embodiment of the disclosure includes a power supply 201, an operation unit 202, a control signal generating unit 203, and a transmitting unit 204. Referring to FIG. 6, the controller 2 of FIG. 5 further includes a single operation lever 211, four operation switches 212, and two display lamps 213. The controller 2 is not limited to the configurations of FIG. 5 and FIG. 6, and may further include another interface, such as a touch panel.

The user may control the traveling of the autonomous traveling vehicle 1 by tilting the operation lever 211 in a forward, backward, rightward, or leftward direction, or any other direction. When the operation lever 211 is tilted forward, the autonomous traveling vehicle 1 increases a positive (forward) speed component, and when the operation lever 211 is tilted backward, the autonomous traveling vehicle 1 increases a negative (backward) speed component. When the operation lever 211 is tilted rightward, the autonomous traveling vehicle 1 increases a positive (clockwise turning) speed, and when the operation lever 211 is tilted leftward, the autonomous traveling vehicle 1 increases a negative (counterclockwise turning) component.

When the operation lever 211 is tilted in a slant direction, the slant component is decomposed into a fore-aft direction and a lateral direction, and an increase in the speed component and an increase in the turning component of the autonomous traveling vehicle 1 are calculated from the decomposed components.

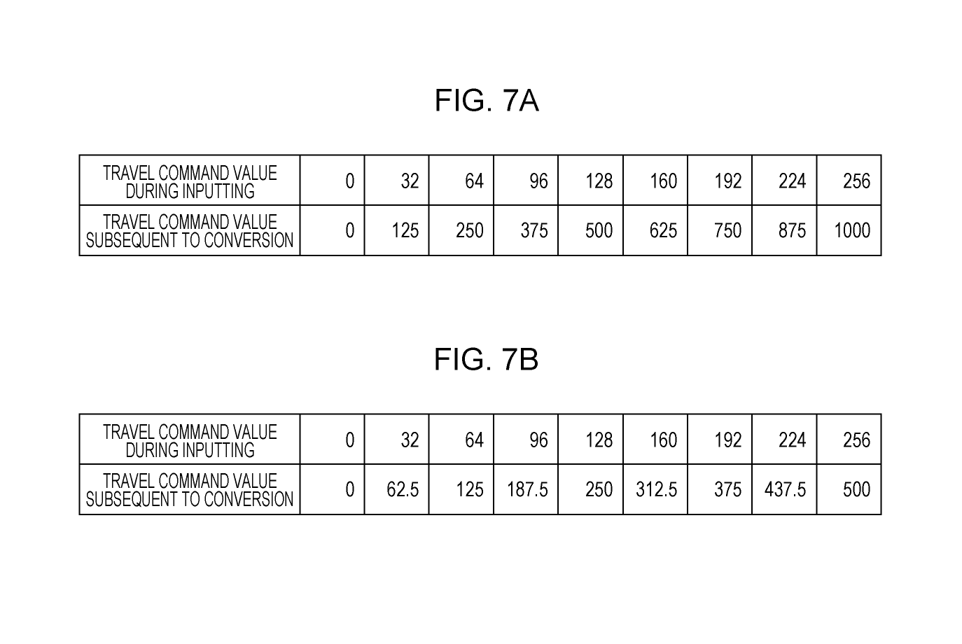

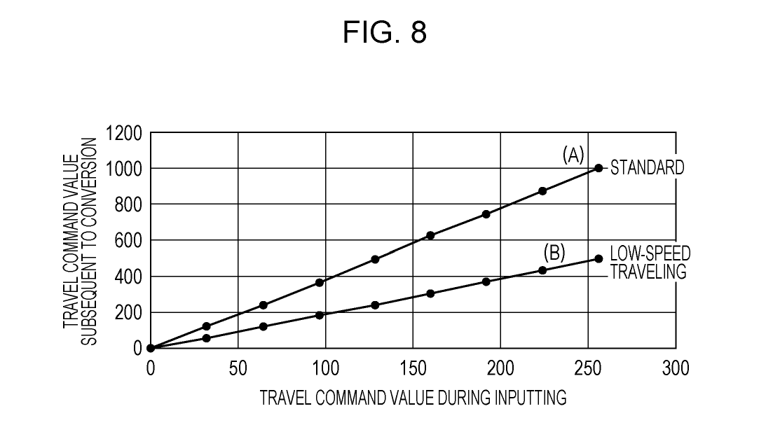

FIG. 7A and FIG. 7B are tables indicating a correspondence relationship of the input and converted travel command values in travel command value conversion tables. FIG. 7A indicates an example of the correspondence relationship of the input and converted travel command values during normal traveling of the vehicle, and FIG. 7B indicates an example of the correspondence relationship of the input and converted travel command values during low-speed traveling of the vehicle. FIG. 8 illustrates graphs indicating the correspondence relationship of the input and converted travel command values in the travel command value conversion tables of FIG. 7A and FIG. 7B. Although travel command values take negative values, FIG. 7A, FIG. 7B, and FIG. 8 do not indicate the negative values because they are symmetrical with the positive values with respect to the origin.

As illustrated in FIG. 7A, FIG. 7B, and FIG. 8, normal-seed traveling (A) has the converted travel command values twice as high as those in the low-speed traveling (B). For this reason, when the operation lever 211 is tilted, the number of revolutions of the electric motors 41R and 41L is higher in the normal-speed traveling (A) than in the low-speed traveling (B).

Referring to FIG. 7A, FIG. 7B, and FIG. 8, the autonomous traveling vehicle 1 travels forward and backward. When the autonomous traveling vehicle 1 turns clockwise or counterclockwise, the travel command value responsive to the numbers of revolutions of the right and left electric motors 41R and 41L stored in the travel command value conversion table are used.

The motor controller 108 drives the electric motors 41R and 41L at the number of revolutions responsive to the converted travel command value input from the travel command converter 106.

The electric motors 41R and 41L individually rotate the front or back pair of right and left wheels in response to a control signal from the motor controller 108. Travel control of autonomous traveling vehicle in manual mode

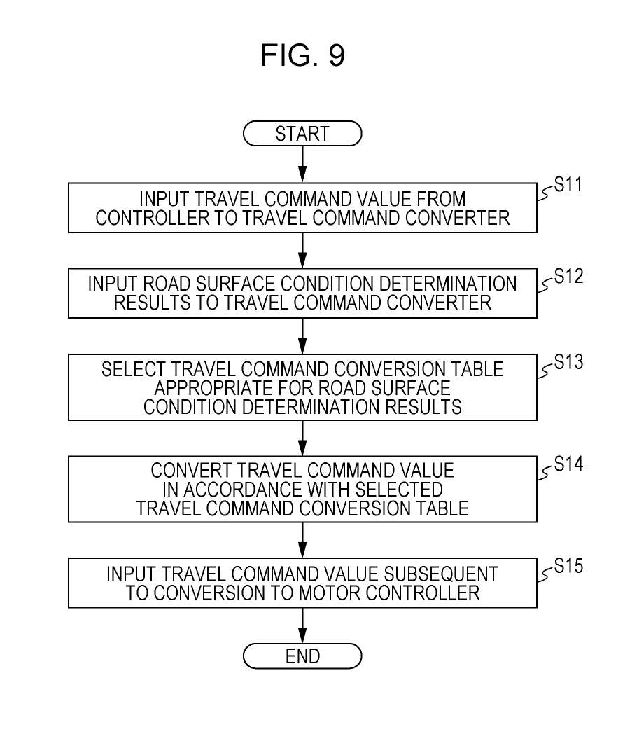

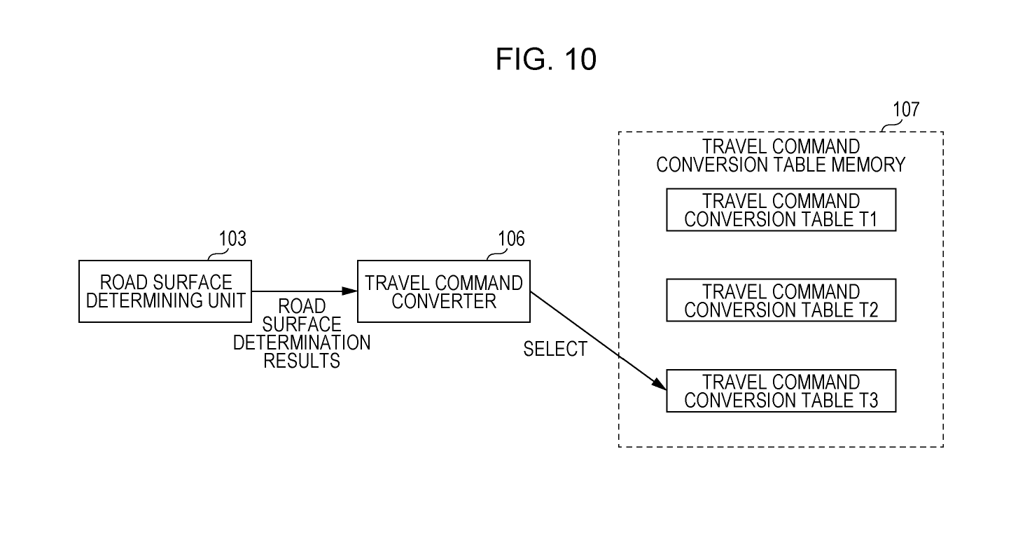

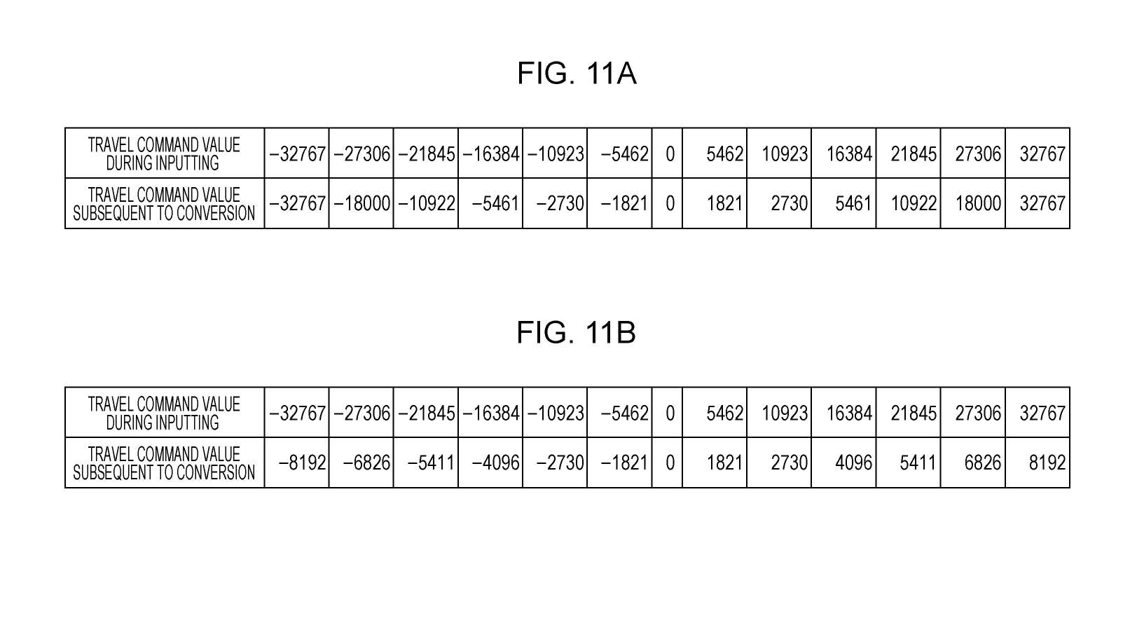

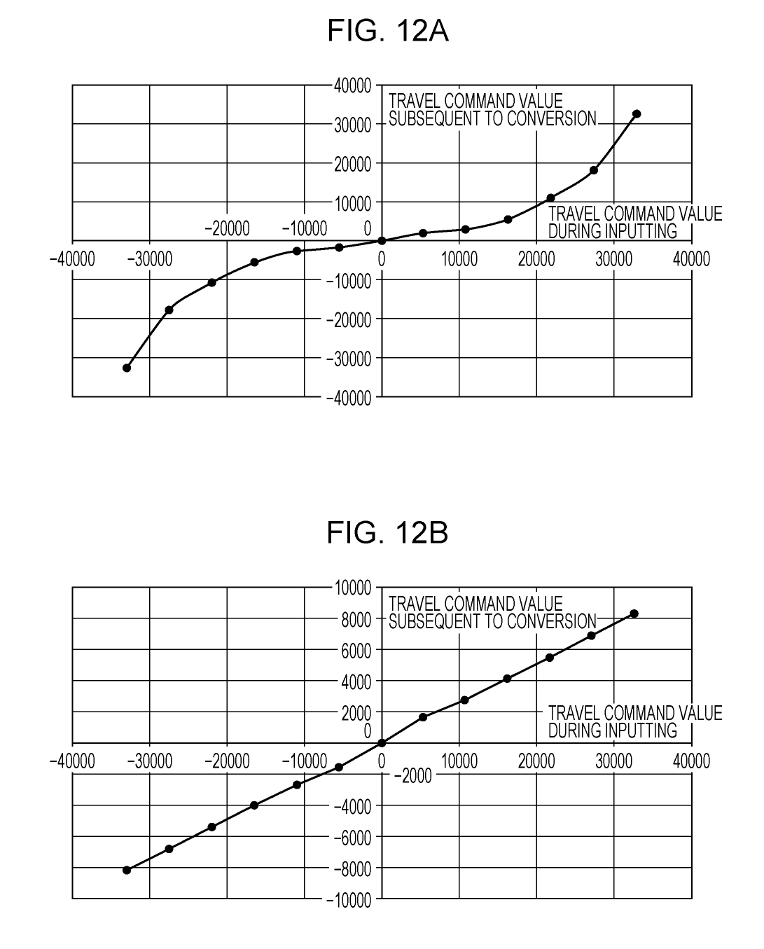

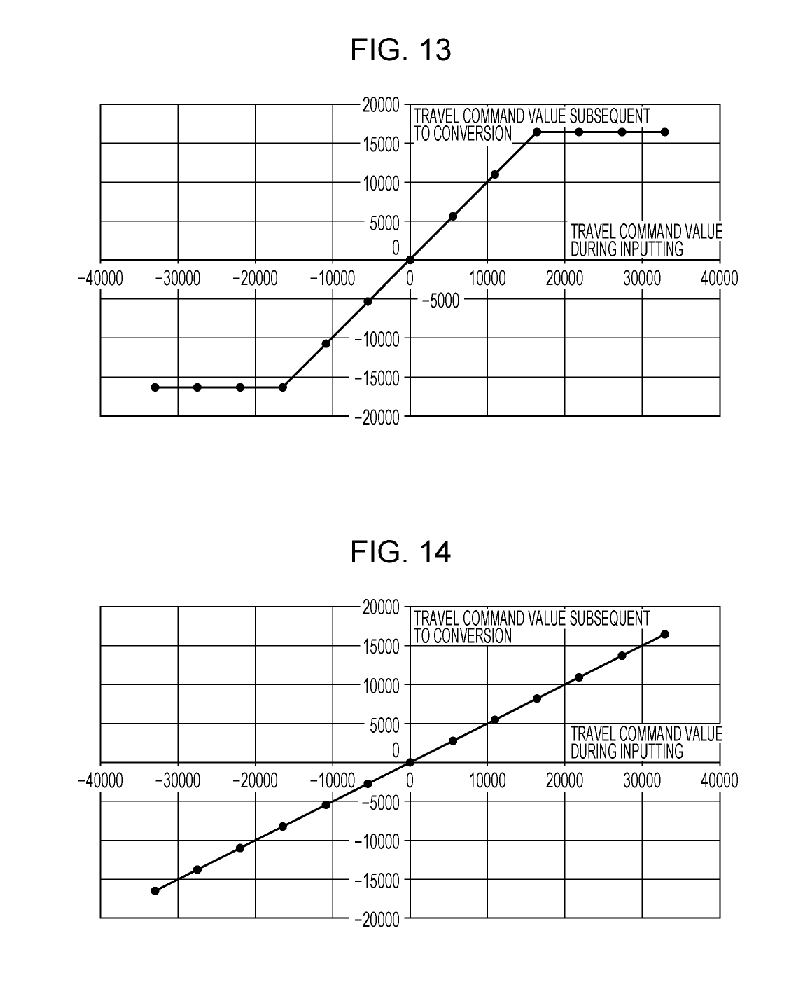

Travel control of the autonomous traveling vehicle 1 in manual traveling is described with reference to FIG. 9 through FIG. 14. FIG. 9 is a flowchart illustrating a travel control process of the autonomous traveling vehicle 1 in the manual traveling. FIG. 10 diagrammatically illustrate show a travel command value conversion table is selected. FIG. 11A and FIG. 11B are tables indicating a correspondence relationship of input and converted travel command values in travel command value conversion tables for a narrow road. FIG. 11A indicates an example of the conversion relationship of the travel command values of a speed component. FIG. 11B indicates an example of the conversion relationship of the travel command values of a turning component. FIG. 12A and FIG. 12B are graphs indicating the conversion relationships of the travel command values in terms of the speed component and the turning component. FIG. 12A indicates an example of the conversion relationship of the travel command values in the speed component, and FIG. 12B indicates an example of the conversion relationship of the travel command values in the turning component. FIG. 13 is a graph indicating an example of the conversion relationship of the travel command values in the speed component of an autonomous traveling vehicle 1 of related art. FIG. 14 is a graph indicating an example of the conversion relationship of the travel command values in the speed component of the autonomous traveling vehicle of the first embodiment.

When the autonomous traveling vehicle 1 starts traveling in the manual travel mode, the external travel command unit 105 inputs in step S11 of FIG. 9 to the travel command converter 106 the travel command value responsive to the input value received via the communication unit 104 from the controller 2.

In step S12, the road surface determining unit 103 input to the travel command converter 106 the road surface determination results based on the measurement data measured by the distance detection device 12.

In step S13, the travel command converter 106 selects a travel command value conversion table appropriate for the road surface determination results input from the road surface determining unit 103, from multiple travel command value conversion tables stored on the travel command conversion table memory 107.

If three travel command value conversion tables T1, T2, and T3 are stored on the travel command conversion table memory 107 as illustrated in FIG. 10, the travel command converter 106 selects an appropriate travel command value conversion table, based on the determination results of the road surface determining unit 103.

In step S14, the travel command converter 106 converts the travel command value input from the external travel command unit 105 in accordance with the selected travel command value conversion table.

In step S15, the travel command converter 106 inputs the converted travel command value to the motor controller 108.

In the example of FIG. 11A and FIG. 11B, a value within a range of from −32767 to +32767 is assigned to an input travel command value. The maximum value, the minimum value, and the step width of the travel command values are set to be any values.

The speed component and the turning component may not necessarily have to have the same conversion relationship of the travel command values, but may have different conversion relationships of the travel command values as illustrated in FIG. 11A and FIG. 11B, and FIG. 12A and FIG. 12B.

FIG. 12B illustrates a proportional conversion relationship of the travel command values in the turning component. FIG. 12A illustrates a conversion relationship of the travel command values in the speed component in which the converted travel command value varies in a smaller rate of change when the travel command value during the inputting is smaller, and the converted travel command value varies in a larger rate of change when the travel command value during the inputting is larger.

The conversion enables fine speed control to be performed immediately subsequent to the start of the traveling of the autonomous traveling vehicle 1, thereby increasing safety in the driving of the autonomous traveling vehicle 1 at a narrow road width. When the autonomous traveling vehicle 1 is sufficiently accelerated, acceleration and deceleration control becomes easier, causing the operability of the controller 2 to be increased.

During the manual traveling, the travel command value input from the operation lever 211 is converted in accordance with an appropriate travel command value conversion table selected in response to the determination results of the road condition. The traveling apparatus may thus be implemented that performs appropriate speed control on the vehicle in response to the travel environment without reducing the operability of the controller 2.

Methods available in the related art increase the safety of the traveling of the vehicle in a narrow road. As illustrated in FIG. 13, in one such method, the speed is limited by setting maximum and minimum limits on the magnitude of the converted travel command value. With such a method, however, even if the operation lever 211 is tilted forward or backward beyond the range of from the maximum limit to the minimum limit, such an operation is not reflected in the speed of the vehicle. The operation range of the operation lever 211 is limited to a narrow range, causing the user's operation to be difficult.

On the other hand, in the autonomous traveling vehicle 1 of the first embodiment of the disclosure, the maximum value and the minimum value of the converted travel command values are set to be smaller while a linear relationship is maintained in the travel command values as illustrated in FIG. 14. In this way, the traveling apparatus is thus implemented that performs the appropriate control on the vehicle without reducing the operability of the controller 2. Travel control of autonomous traveling vehicle during autonomous traveling

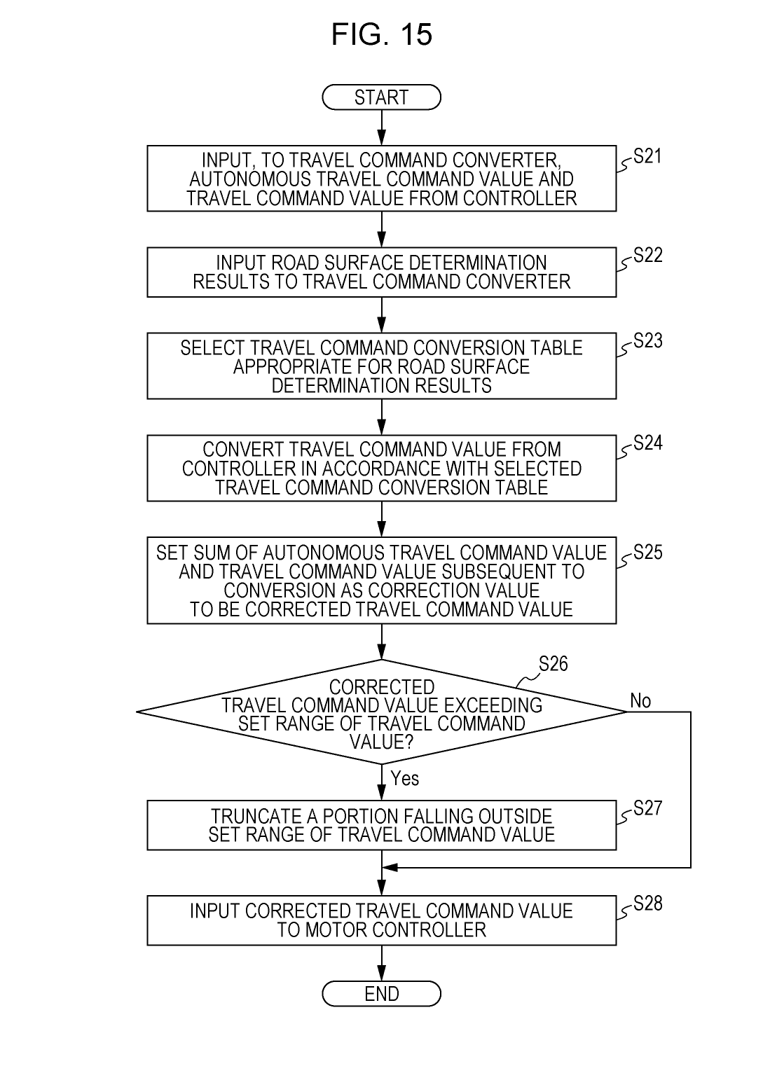

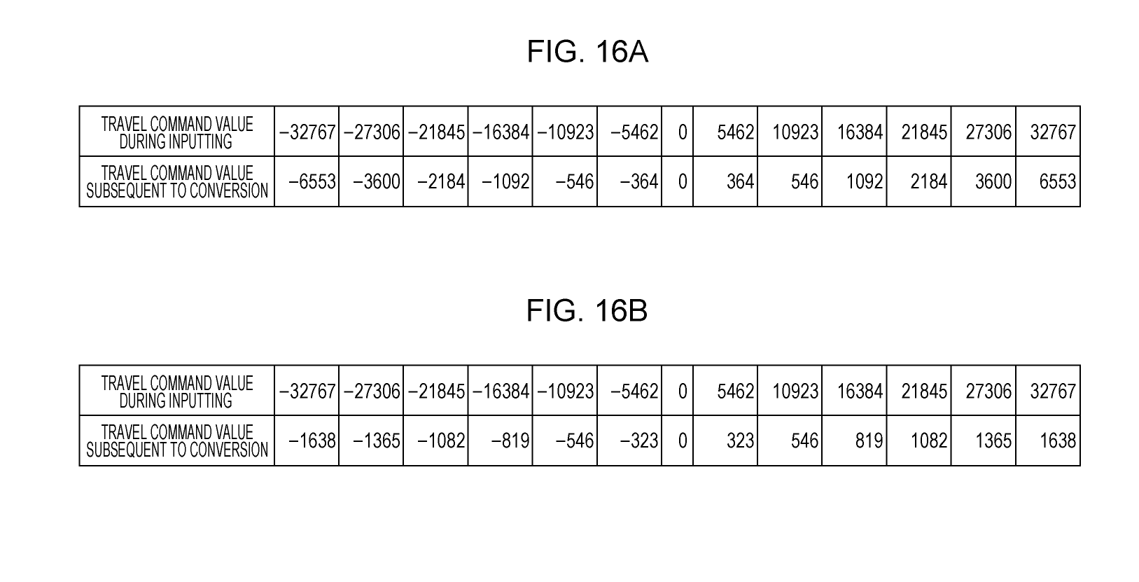

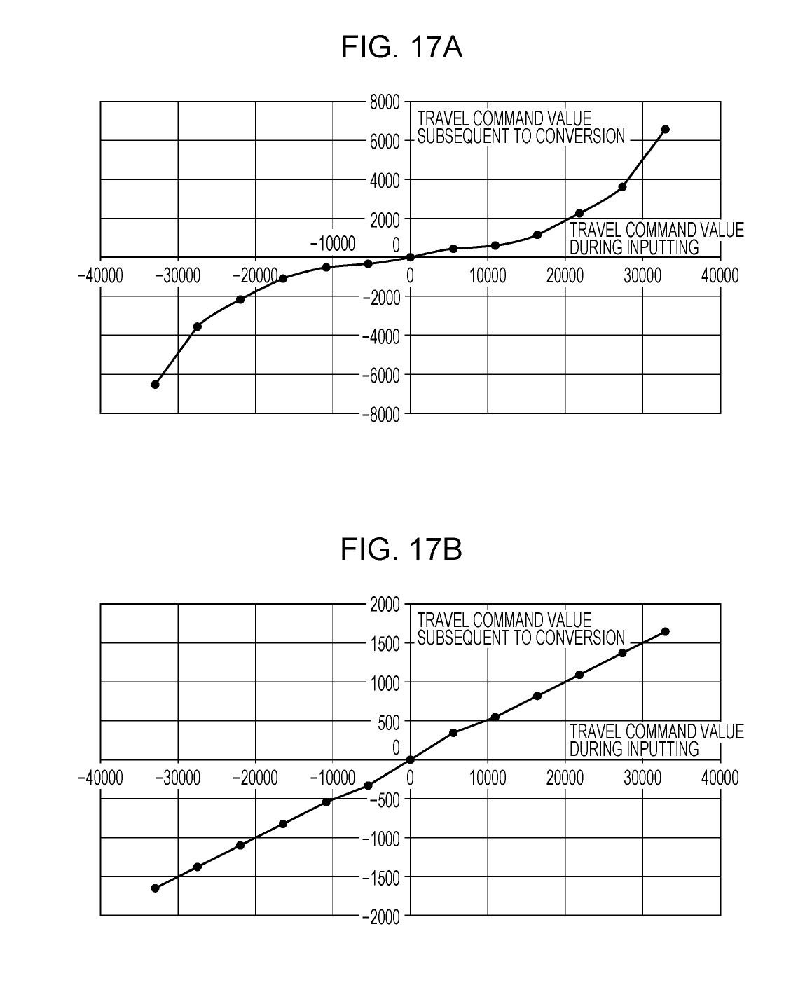

The travel control of the autonomous traveling vehicle 1 during the autonomous traveling is described with reference to FIG. 15 through FIG. 17A and FIG. 17B. FIG. 15 is a flowchart illustrating a travel control process of the autonomous traveling vehicle 1 during the autonomous traveling. FIG. 16A and FIG. 16B are tables indicating the conversion relationships of the input and converted travel command values in the travel command value conversion tables for a narrow width road. FIG. 16A indicates an example of the conversion relationship of the travel command values in the speed component, and FIG. 16B indicates an example of the conversion relationship of the travel command values in the turning component. FIG. 17A and FIG. 17B are graphs indicating the conversion relationships of the travel command values in terms of the speed component and the turning component. FIG. 17A indicates an example of the conversion relationship of the travel command values in the speed component, and FIG. 17B indicates an example of the conversion relationship of the travel command values in the turning component.

Steps S22 and S23 of FIG. 15 are respectively identical to steps S12 and S13 of FIG. 9, and the discussion thereof is omitted herein. Operations in steps S21, and S24 through S28, not illustrated in FIG. 9, are described below.

When the autonomous traveling vehicle 1 starts traveling in the autonomous traveling mode, in step S21 of FIG. 15, the autonomous traveling controller 102 inputs an autonomous travel command value to the travel command converter 106, and the external travel command unit 105 inputs a travel command value from the controller 2 to the travel command converter 106.

In step S24, the travel command converter 106 converts the travel command value in accordance with the selected travel command value conversion table (step S24).

In step S25, the travel command converter 106 adds the converted travel command value as a correction value to the autonomous travel command value, thereby obtaining a corrected travel command value.

Let ASP and AST respectively represent the autonomous travel command value in the speed component and the autonomous travel command value in the turning component, and let MSP and MST respectively represent the corrected travel command value in the speed component and the corrected travel command value in the turning component. The corrected travel command values CSP and CST in the speed component and the turning component are respectively expressed as follows:

CSP=ASP+MSP

CST=AST+MST

In step S26, the travel command converter 106 determines whether the corrected travel command value exceeds the set range of the travel command values.

If the travel command converter 106 determines that the corrected travel command value exceeds the set range of the travel command values (yes branch from step S26), the travel command converter 106 truncates an excess travel command value beyond the set range (step S27). The travel command converter 106 performs an operation in step S28.

If the corrected travel command value does not exceed the set range of the travel command values (no branch from step S26), the travel command converter 106 performs the operation in step S28.

Finally in step S28, the travel command converter 106 inputs the corrected travel command value to the motor controller 108 (step S28).

The conversion relationships of manual travel command values in the speed component and the turning component illustrated in FIG. 16A, FIG. 16B, FIG. 17A, and FIG. 17B are identical to the conversion relationships of the manual travel command values in the speed component and the turning component illustrated in FIG. 11A, FIG. 11B, FIG. 12A, and FIG. 12B. Note that the converted manual travel command values of FIG. 16A, FIG. 16B, FIG. 17A, and FIG. 17B are different from the converted manual travel command value of FIG. 11A, FIG. 11B, FIG. 12A, and FIG. 12B in that each manual travel command value of FIG. 16A, FIG. 16B, FIG. 17A, and FIG. 17B is about one-fifth in magnitude each manual travel command value of FIG. 11A, FIG. 11B, FIG. 12A, and FIG. 12B.

If the converted manual travel command value is too large with respect to the autonomous travel command value, the autonomous traveling is difficult to control, and the safety of the autonomous traveling vehicle 1 may be degraded. During the autonomous traveling, the manual travel command value subsequent to the conversion is set to be relatively smaller in magnitude than the autonomous travel command value such that control via the autonomous traveling works in a standard way with control via the manual traveling working in a corrective way.

### Second Embodiment

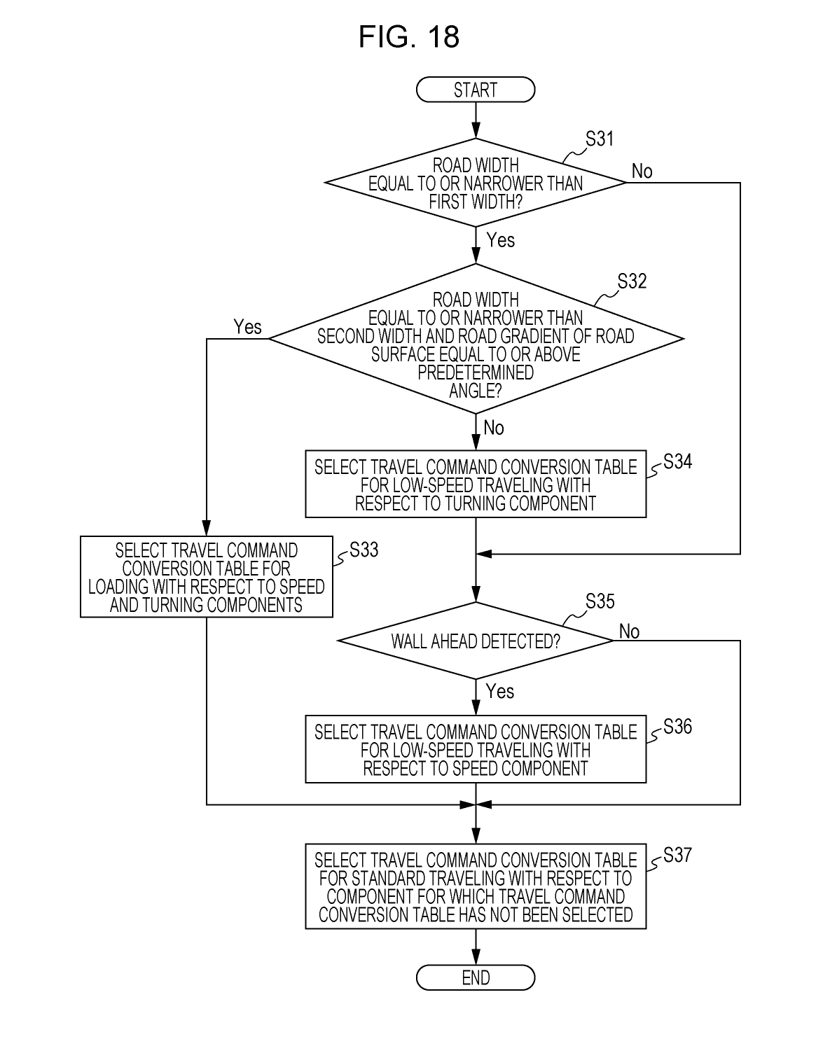

The travel control of the autonomous traveling vehicle 1 of a second embodiment of the disclosure is described with reference to FIG. 18. FIG. 18 is a flowchart illustrating an example of a selection process of the travel command value conversion tables of the autonomous traveling vehicle 1 of the second embodiment of the disclosure.

In accordance with the second embodiment, the travel command conversion table memory 107 stores at least three types of travel command value conversion tables for the normal-speed traveling, the low-speed traveling, and for loading onto the bed of a truck with respect to the speed component and the turning component as illustrated in the following table.

| | Speed component | Turning component |
|---|---|---|
| 1 | Normal-speed | Normal-speed |
| 2 | Low-speed | Low-speed |
| 3 | Loading | Loading |

In step S31 of FIG. 18, the road surface determining unit 103 determines whether a road width detected by the distance detection device 12 is equal to or narrower that a first width (step S31). The first width is different depending on the size and speed of the autonomous traveling vehicle 1. For example, if the autonomous traveling vehicle 1 has a size of 1 m×1 m, the first width ranges from about 7 m to 8 m.

If the road width is equal to or narrower than the first width (yes branch from step S31), the road surface determining unit 103 performs a determination operation in step S32. On the other hand, if the road width is wider than the first width (no branch from step S31), the road surface determining unit 103 performs a determination operation in step S35.

In step S32, the road surface determining unit 103 determines whether the road width is equal to or narrower than a predetermined second width and whether the gradient angle of the road is equal to or above a predetermined angle. The determination operation in step S32 is performed to determine whether the autonomous traveling vehicle 1, such as a truck, is loaded or not. The second width is the width of the bed of the truck (2 m, for example), and the gradient falls within a range of about 10 to 15 degrees.

If the road width is equal to or narrower than the second width, and the gradient angle of the road is equal to or above the predetermined angle (yes branch from step S32), the travel command converter 106 selects the travel command value conversion table for loading the autonomous traveling vehicle 1 with respect to the speed component and turning component in step S33.

If the road width is wider than the second width or the gradient angle of the road is smaller than the predetermined angle (no branch from step S32), the travel command converter 106 selects the travel command value conversion table for the low-speed traveling with respect to the turning component in step S34.

In step S35, the road surface determining unit 103 determines whether an obstacle having a predetermined width is present ahead. For example, the road surface determining unit 103 determines whether an obstacle having a width of about 20 to 30 cm has been detected about 5 to 6 m ahead of the autonomous traveling vehicle 1.

If the road surface determining unit 103 has detected an obstacle having a predetermined width ahead (yes branch from step S35), the travel command converter 106 selects the travel command value conversion table for the low-speed traveling in step S36.

If the road surface determining unit 103 has not detected any obstacle having a predetermined width ahead (no branch from step S35), the travel command converter 106 selects in step S37 the travel command value conversion table for the normal-speed traveling with respect to the component for which no travel command value conversion table has been selected.

In this way, an appropriate travel command value conversion table is selected in view of a variety of road conditions, and the traveling apparatus is implemented that appropriately performs speed control in response to the travel environment without reducing the operability of the controller 2.

### Third Embodiment

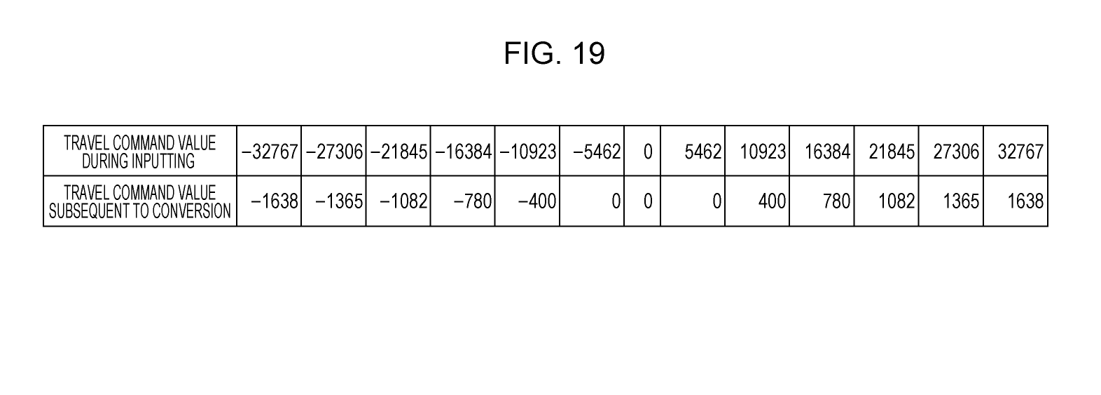

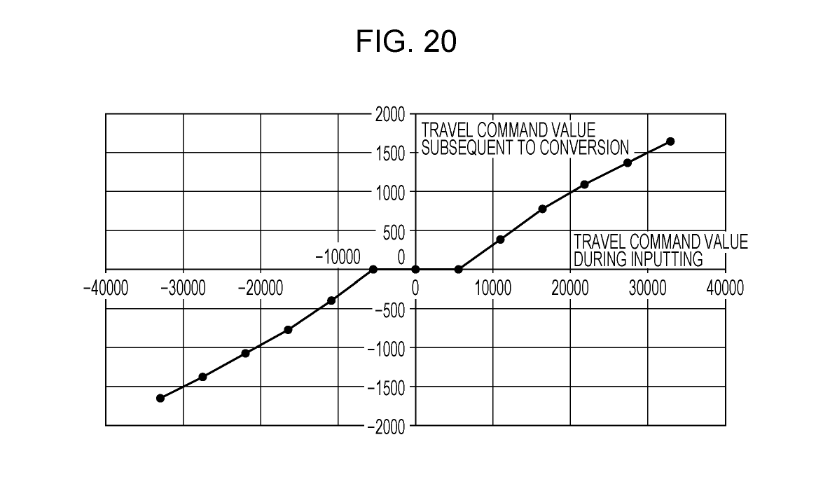

An autonomous traveling vehicle 1 of a third embodiment is described with reference to FIG. 19 and FIG. 20. FIG. 19 is a table illustrating the conversion relationship of the input and converted travel command values in the travel command value conversion tables in the turning component for a wide area. FIG. 20 is a graph indicating the conversion relationship of the travel command values in the turning component of FIG. 19.

When the road surface determining unit 103 determines that the autonomous traveling vehicle 1 is traveling in a wide area in accordance with the third embodiment, the travel command converter 106 selects the travel command value conversion table of FIG. 19 for the turning component. The “wide area” is different depending on the size and speed of the autonomous traveling vehicle 1. For example, if the autonomous traveling vehicle 1 has a size of 1 m×1 m, the wide area refers to an area of about 10 m×10 m to 20 m×20 m.

Referring to FIG. 19 and FIG. 20, the travel command value subsequent the conversion is 0 if the travel command value during the inputting ranges from −5462 to +5462. In this way, even if the operation lever 211 is slightly tilted laterally, the autonomous traveling vehicle 1 does not turn right or left. As a result, the range of lateral play of the operation lever 211 increases, thereby increasing a straight-traveling stability. The range of play may be varied in response to the width of the road determined by the road surface determining unit 103 (for example, the wider the road width is, the smaller the range of width play is set).

Even if the operation lever 211 is slightly tiled in the wide area, the traveling apparatus 1 that maintains the straight-traveling stability is thus implemented.

### Fourth Embodiment

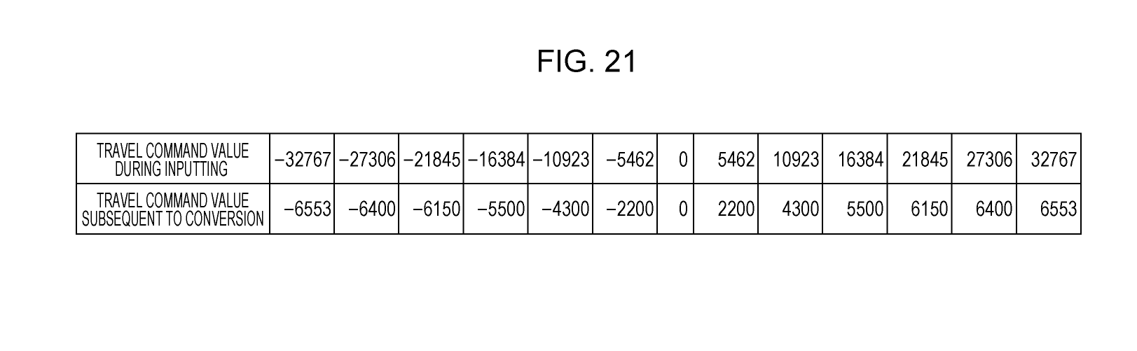

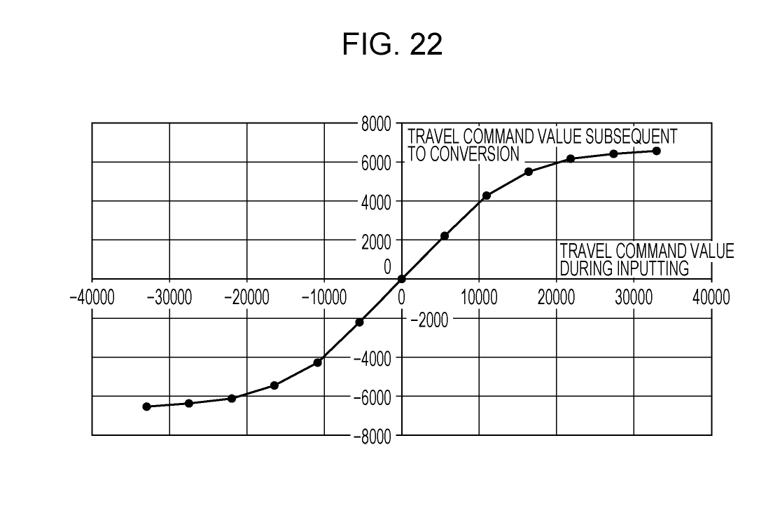

The travel control of an autonomous traveling vehicle 1 of a fourth embodiment is described with reference to FIG. 21 and FIG. 22. FIG. 21 is a table indicating the correspondence relationship of the input and converted travel command values in the travel command value conversion table in the speed component for a high-speed region. FIG. 22 is a graph indicating the conversion relationship of the travel command values in the speed component of FIG. 21.

In accordance with the fourth embodiment, if the road surface determining unit 103 determines that the autonomous traveling vehicle 1 is traveling in a high-speed range, the travel command converter 106 selects the travel command value conversion table of FIG. 21 for the speed component. The “high-speed range” refers to a range of from about 4.5 to about 5.5 km/h.

Referring to FIG. 21 and FIG. 22, the input and converted travel command values are approximately proportional with the input travel command values ranging from −10000 to +10000. In this way, a slight tilting of the operation lever 211 in the fore-aft direction causes the autonomous traveling vehicle 1 to reach a speed close to a high speed. A fine adjustment of speed in the high speed range is easy to perform. The traveling apparatus having a high operability of the controller 2 in the high-speed range is thus implemented.

### Fifth Embodiment

The communication unit 104 may change a detection interval of a signal, received from the controller 2, in response to the determination results of the road surface determining unit 103. For example, the detection interval of the signal from the controller 2 is set to be shorter in a narrow area, thereby increasing the sensitivity of the operability of the controller 2.

If the autonomous traveling vehicle 1 has a size of 1 m×1 m, the “narrow area” may be intended to mean an area of about 6 m×6 m to about 7 m×7 m surrounding the autonomous traveling vehicle 1, and more preferably, an area of about 5 m×5 m surrounding the autonomous traveling vehicle 1, from within which an obstacle is detected.

### Sixth Embodiment

The travel command converter 106 may convert the travel command values such that acceleration or deceleration changes in response to the determination results of the road surface determining unit 103. For example, the autonomous traveling vehicle 1 may be implemented that has a higher response during the low-speed traveling by increasing a rate of change in speed per second to increase acceleration in the narrow area.

Specifically, when the travel command converter 106 gives a travel command to the motor controller 108 as illustrated in FIG. 4, the motor controller 108 performs acceleration control by gradually increasing speed to a target speed instead of immediately reflecting the given travel command in motor rotation. This is because a sudden start of the vehicle is controlled even if a command for a maximum speed is entered in the state of 0 speed. In this way, the vehicle response is increased by sharply changing an acceleration curve.

### Seventh Embodiment

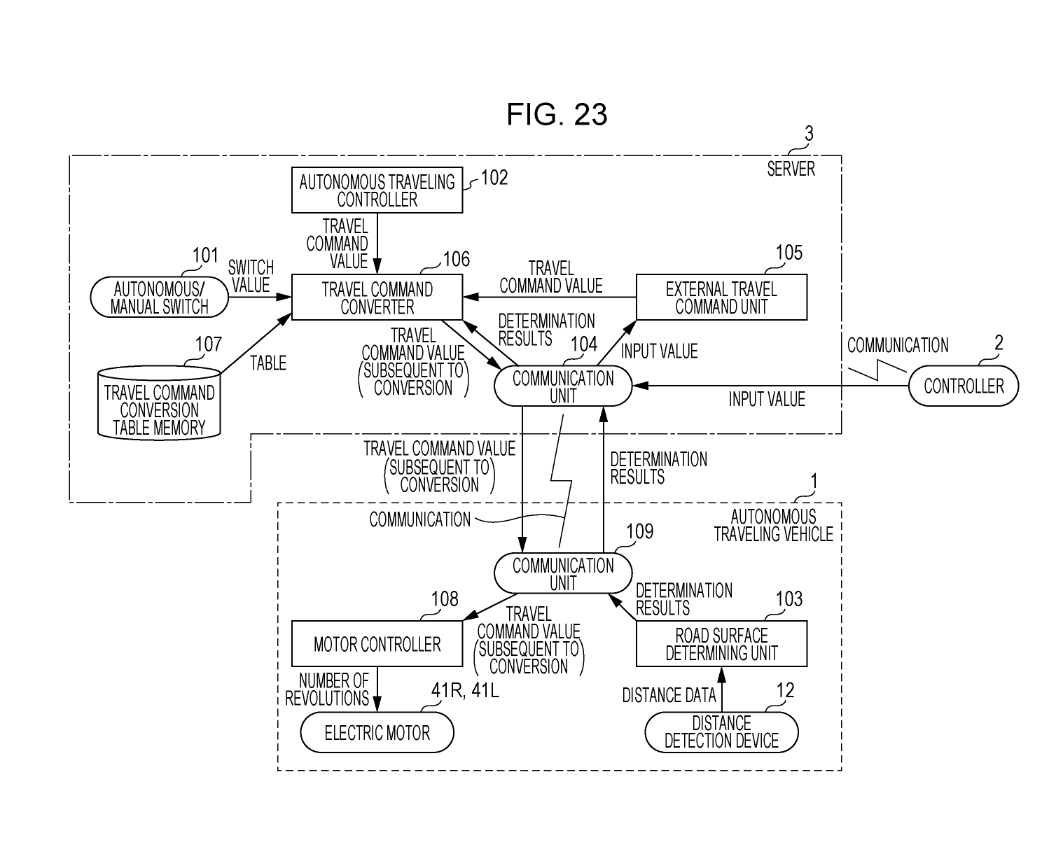

A traveling system of a seventh embodiment of the disclosure is described with reference to FIG. 23. FIG. 23 is a functional block diagram diagrammatically illustrating the traveling system of the seventh embodiment.

Referring to FIG. 23, the traveling system of the seventh embodiment includes the autonomous traveling vehicle 1, controller 2, and server 3. The autonomous traveling vehicle 1 includes the distance detection device 12, the road surface determining unit 103, the motor controller 108, the communication unit 109, the electric motors 41R and 41L. The server 3 includes the autonomous/manual switch 101, the autonomous traveling controller 102, the communication unit 104, the external travel command unit 105, the travel command converter 106, and the travel command conversion table memory 107. The elements of FIG. 23 are identical to those of FIG. 4, and the discussion thereof is omitted herein.

In accordance with the first embodiment, the elements in the autonomous traveling vehicle 1 are related to the travel control. In accordance with the seventh embodiment, the external server 3 performs the travel control of the autonomous traveling vehicle 1 by communicating with the autonomous traveling vehicle 1.

### MODIFICATIONS

In a modification of the seventh embodiment, the controller 2 and the server 3 may be integrated to perform the travel control of the autonomous traveling vehicle 1.

In this way, low-cost and light-weight design may be achieved in the components of the autonomous traveling vehicle by arranging the configuration related to the travel control external to the autonomous traveling vehicle 1.

In accordance with the first through seventh embodiments, and the modification, the travel control of the traveling vehicle is performed. The disclosure is not limited to these embodiments. The disclosure is applicable to an operation device that performs a predetermined operation in response to an operation command from the external control device and is thus controlled by the device. For example, the operation device includes not only the traveling apparatus, but also an apparatus, such as a humanoid robot, an arm or a shovel mounted on the traveling vehicle.

The present disclosure contains subject matter related to that disclosed in Japanese Priority Patent Application JP 2017-102022 filed in the Japan Patent Office on May 23, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A traveling apparatus, comprising:
a housing;
a travel driving unit that drives the housing such that the housing travels along a road surface;
a travel environment information acquisition unit that acquires travel environment information concerning an environment around the housing;
a communication unit that receives a first travel command value responsive to a travel command from an external control device to the housing;
a travel command value converting unit that converts the first travel command value into a second travel command value; and
a travel control unit that controls the travel driving unit in response to the second travel command value,
wherein the travel command value converting unit varies a conversion rate from the first travel command value to the second travel command value in accordance with the travel environment information.

2. The traveling apparatus according to claim 1, wherein the travel environment information comprises information concerning a state of the road surface.

3. The traveling apparatus according to claim 1, wherein the travel environment information comprises information concerning an obstacle present around the housing.

4. The traveling apparatus according to claim 1, further comprising a memory that stores conversion data that indicates a conversion relationship from the first travel command value to the second travel command value,
wherein if the memory stores a plurality of pieces of the conversion data responsive to the travel environment information, the travel command value converting unit converts the first travel command value into the second travel command value in accordance with a single piece of the conversion data selected from the plurality of pieces of the conversion data in view of the travel environment information.

5. The traveling apparatus according to claim 1, further comprising an autonomous travel control unit that generates an autonomous travel command value for autonomous traveling of the housing,
wherein if the first travel command value is received during the autonomous traveling of the housing, the travel control unit controls the travel driving unit in response to the autonomous travel command value and the second travel command value.

6. The traveling apparatus according to claim 5, wherein if the communication unit receives the first travel command value during the autonomous traveling of the housing, the travel command value converting unit converts the first travel command value into the second travel command value such that the second travel command value is smaller than the autonomous travel command value, and, if a sum of the autonomous travel command value and the second travel command value exceeds a predetermined range, truncates an amount of the value of the sum in excess of the predetermined range.

7. The traveling apparatus according to claim 1, wherein the travel environment information comprises information concerning a width of the road surface.

8. The traveling apparatus according to claim 1, wherein the travel environment information comprises information concerning a road gradient of the road surface.

9. The traveling apparatus according to claim 1, wherein the travel environment information comprises information concerning a slipping state of the road surface.

10. The traveling apparatus according to claim 1, wherein in response to the travel environment information, the travel command value converting unit varies the conversion rates in a forward direction, a backward direction, a leftward direction and a rightward direction of the housing such that the conversion rate in one direction becomes different from the conversion rate in another direction.

11. The traveling apparatus according to claim 1, wherein the travel environment information comprises information concerning an object present around the housing, and
wherein the travel command value converting unit varies the conversion rate in the forward direction of the housing in response to a detected distance to the object.

12. The traveling apparatus according to claim 1, wherein the travel environment information comprises information concerning an object present around the housing, and
wherein the travel command value converting unit decreases the conversion rate in the forward direction of the housing as a detected distance to the object becomes shorter.

13. The traveling apparatus according to claim 1, wherein if the first command value is equal to or below a reference value, the travel command value converting unit converts the first travel command value into the second command value such that the second command value becomes zero, and varies the reference value in response to the travel environment information.

14. The traveling apparatus according to claim 1, wherein the communication unit varies in response to the travel environment information a time interval according to which the first travel command value is received from the external control device.

15. The traveling apparatus according to claim 1, wherein the travel command value converting unit varies a rate of acceleration or a rate of deceleration of the traveling of the housing in response to the travel environment information until the housing reaches a travel speed corresponding to the second travel command value.

16. A traveling system comprising a traveling apparatus, a control device, and a server,
wherein the control device includes an operation unit that receives a travel command to the traveling apparatus, and
a control device transmitting unit that transmits a first travel command value responsive to the travel command,
wherein the server includes a server receiving unit that receives the first travel command value from the control device, and receives, from the traveling apparatus, travel environment information concerning an environment around the traveling apparatus,
a travel command value converting unit that converts the first travel command value into a second travel command value, and
a server transmitting unit that transmits the second travel command value to the traveling apparatus, and
wherein the traveling apparatus includes
a housing,
a travel driving unit that drives the housing such that the housing travels along a road surface,
a travel environment information acquisition unit that acquires the travel environment information concerning the environment around the housing,
a traveling apparatus transmitting unit that transmits the travel environment information to the server,
a traveling apparatus receiving unit that receives the second travel command value from the server, and
a travel control unit that controls the travel driving unit in response to the second travel command value,
wherein the travel command value converting unit varies a conversion rate from the first travel command value to the second travel command value in accordance with the travel environment information.

17. An operation device comprising:
an operation unit that performs a predetermined operation in response to an operation command from an external control device;
an environment information acquisition unit that acquires environment information concerning an environment around the operation unit;
a communication unit that receives a first operation command value responsive to the operation command from the external control device to the operation unit;
an operation command value converting unit that converts the first operation command value into a second operation command value; and
an operation control unit that controls an operation of the operation unit in response to the second operation command value,
wherein the operation command value converting unit varies a conversion rate from the first operation command value to the second operation command value in accordance with the environment information.
